(19) United States
(12) Patent Application Publication
(10) Pub. No.: US 2005/0117827 A1
(43) Pub. Date: Jun. 2, 2005

(54) Rolling bearing

(75) Inventors: Osamu Fujii, Kanagawa (JP); Takashi Murai, Kanagawa (JP); Kenji Kotaki, Kanagawa (JP); Yukio Ooura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD., Tokyo (JP)

(21) Appl. No.: 10/501,213

(22) PCT Filed: Jan. 9, 2003
(86) PCT No.: PCT/JP03/00131

(30) Foreign Application Priority Data
Jan. 11, 2002 (JP) 2002-005034
Dec. 9, 2002 (JP) 2002-357237

(51) Int. Cl. F16C 43/06

(52) U.S. Cl. 384/510

(57) ABSTRACT

To provide a rolling bearing in which a spin slippage between a rolling element and a raceway groove is suppressed, and a rolling resistance is reduced to make the torque lower, whereby the rolling elements are easily incorporated even when the bearing rings are the monolithic type. Also, to provide the rolling bearing in which the rolling elements are easily incorporated even in a state where the bearing rings of monolithic type and a retainer are assembled. After the outer and inner races and the retainer are assembled, a small groove 4 for rotating the rolling element is provided in the center of an inner raceway groove 3 within a raceway groove space. The retainer 6 is only provided in one axial pocket face 7b of a pocket 7, and the other face is opened.

### TECHNICAL FIELD

The present invention relates to a rolling bearing that can receive a radial load, a bidirectional axial load, and a moment load, in which the bearing is used for an industrial machine, a robot, a medical facility, a food apparatus, a semiconductor/liquid crystal manufacturing apparatus, a direct drive motor, and an optical and opto-electronics apparatus.

Also, this invention relates to a direct drive motor that is capable of driving a load directly connected to the motor without using a speed reducer.

### BACKGROUND ART

As a bearing that can singly receive a radial load, a bidirectional axial load and a moment load, a crossed roller bearing, a four point contact ball bearing and a three point contact ball bearing have been conventionally well known.

The crossed roller bearing has an advantage of great moment rigidity, because a rolling element is a roller, and in line contact with a bearing ring at two points.

The four point contact ball bearing or three point contact ball bearing has an advantage of lower torque and smooth operation, because a rolling element is a ball, and in point contact with the bearing ring at four points or three points.

One example of the conventional direct drive motor is shown in FIG. 35. In the direct drive motor of this type, the bearing supporting the rotation and load employs a crossed roller bearing, for example, as shown in FIG. 36. The bearing has an outer race 200 fitted with a rotor 17 and secured with a pulsar ring 19, and an inner race 201 fitted with a stator 18 and secured with a position transducer 20. And the rotor 17 and the pulsar ring 19 are rotated by energizing a coil 21, so that the position transducer 20 detects the irregularity of the pulsar ring 19, and the rotation speed and positioning are controlled by a controller.

The crossed roller bearing is employed as the bearing for the direct drive motor, because of the requirements of (1) high load capacity, (2) high rigidity, and (3) a simple motor structure.

That is, the crossed roller bearing has a rolling element 300 that is a cylindrical roller, as shown in FIG. 35, whereby the rolling elements 300 are arranged orthogonal to each other and subjected to a preload to realize the high load capacity and high rigidity.

However, though the crossed roller bearing has an advantage that the moment rigidity is great, there is a relative speed between the rolling element and the bearing ring, causing the roller to be easily skewed, resulting in a disadvantage that the torque variation is likely to occur.

Also, the four point contact ball bearing or three point contact ball bearing has an advantage that the torque is smaller than the crossed roller bearing of the same size, because the rolling element is a ball, but has a disadvantage that the moment rigidity is small. Also, in the case where the radial load is superior to the axial load, or a pure radial load is applied, the spin of ball is large, and a small spin abrasion performance is not obtained, because each ball is contact with the bearing ring at four or three points.

Moreover, to improve the spin abrasion performance even slightly, a clearance of the bearing is usually set positively, so that the moment rigidity of the bearing is reduced.

Thus, to solve the above-mentioned problems, a new and useful rolling bearing has been disclosed in JP-A-2001-50264.

That is, this rolling bearing comprises a plurality of rolling elements 60 that are incorporated between an outer race 30 and an inner race 40 as a pair of bearing rings, each bearing ring 30, 40 having a raceway groove 50 composed of a raceway surface 31, 41 having a larger radius than the radius of the rolling elements 60, at least one bearing ring 30 (40) being composed of two raceway surfaces, in which the rolling elements 60 have an outside diameter 61 of a rolling contact face with a curvature in the axial direction, and are disposed alternately crosswise on the circumference of a circle, and the outside diameter 61 of each rolling element 60 is always contact with the raceway surface 31 (41) of one beating ring 30 (40) and the raceway surface 41 (31) of the other bearing ring 40, which are opposed to each other, at each one point, or at two points in total, as shown in FIG. 37. A specific form of the rolling element 60 is an upper and lower cut ball (with a structure in which the upper and lower portions of a ball are cut away to form the opposing faces, the same in the following specification) having one set of planar portions (opposing faces) 62, 62, the outside diameter 61 being a rolling contact face, as shown in FIGS. 37 and 38.

In JP-A-2001-50264, to stabilize the attitude of the rolling element 60 of the above form, a retainer 70 for retaining and guiding the rolling element 60 with at least two axially opposed faces (axial guide faces) 81, 81 of a pocket 80 was employed (FIGS. 37 and 38). However, to receive the rolling element 60 in the pocket 80 of this retainer 70, at least one of the outer race 30 and the inner race 40 must be divided, when the bearing is practically assembled. Therefore, at the time of assembling, it was required to control a deviation in the radial direction of the divided outer races 30, 30. In the figures, reference numeral 90 is a fastening bolt. Also, there was a significant problem that it was difficult to achieve the low cost of the bearing with a bearing ring division construction.

Also, there is DE4334195 as the rolling bearing employing the above rolling elements 60. However, in DE4334195, the inner and outer races are monolithically constituted, but no special configuration for rotating the rolling element within a groove space formed by the outer race and the inner race is provided for the raceway grooves of the inner race and the outer race. Therefore, especially when a preload is applied, it is difficult to rotate the rolling element within this groove space, and virtually difficult to assemble it.

In the conventional direct drive motor, there was an upper limit on the use rotation speed, because the conventional crossed roller bearing was employed, as illustrated. That is, with this bearing constitution, the rolling elements 300 arranged alternately are cylindrical rollers, and a rolling contact face 301 of the rolling element 300 and a raceway groove 500 of the bearing rings 201, 200 is in line contact, so that the torque of bearing is large and the heating is great, whereby there is a limitation on the use rotation speed.

### DISCLOSURE OF THE INVENTION

This invention has been achieved in the light of the above-mentioned problems associated with the prior arts, and it is a first object of the invention to provide a rolling bearing in which a spin slippage between a rolling element and a raceway groove is suppressed, and a rolling resistance is reduced to make the torque lower, whereby the rolling elements are easily incorporated even when the bearing rings are the monolithic type.

It is another object of the invention to provide the rolling bearing in which the rolling elements are easily incorporated even in a state where the bearing rings of monolithic type and a retainer are assembled.

Also, it is a second object of the invention to provide a direct drive motor having higher speed without impairing the functions of the conventional direct drive motor.

Technical approach of the invention to achieve the first object is a rolling bearing characterized in that a plurality of rolling elements are incorporated between one pair of bearing rings, each of the bearing rings has a raceway groove composed of a raceway surface having a larger radius than the radius of the rolling elements, at least one bearing ring being composed of two raceway surfaces, the rolling elements have an outside diameter of a rolling contact face with a curvature in the axial direction, and are arranged crosswise so that the central axes of rotation of the rolling elements are skewed alternately in the circumferential direction of the bearing rings, an outer peripheral face of each of the rolling elements is always contact with a raceway surface of one bearing ring and a raceway surface of the other bearing ring, which are opposed to each other, at each one point, or two points in total, one pair of bearing rings are monolithically formed, and a groove of desired depth is provided in a part of the raceway groove for either one or both of the bearing rings.

Also, the rolling bearing further comprises a retainer for retaining the plurality of rolling elements between the pair of bearing rings, and the retainer has only one axial pocket face in a pocket for retaining the rolling element, with a face opposed to the axial pocket face being opened, in which the axial pocket faces are arranged inclinedly on the opposite side to each other in the axial direction, corresponding to a direction of inclination of the rolling elements incorporated crosswise to each other in the circumferential direction of the bearing rings. Each of the rolling elements has at least one planar portion, in which the planar portion is contact with the axial pocket face of the retainer.

Also, the rolling bearing further comprises a retainer for retaining the plurality of rolling elements between the pair of bearing rings, and the retainer has only one axial pocket face in a pocket for retaining the rolling element, in which the axial pocket faces are arranged inclinedly on the opposite side to each other in the axial direction, corresponding to a direction of inclination of the rolling elements incorporated crosswise to each other in the circumferential direction of the bearing rings. Each of the rolling elements may be an upper and lower cut ball having one set of opposing faces, the central axis of rotation of the rolling element being orthogonal to the opposing faces.

Moreover, the rolling elements is a one-side cut ball having a cut face, in which the central axis of rotation of the rolling element is orthogonal to the cut face.

With those technical approach, the rolling elements can be inserted in a state where the inner and outer races and the retainer are assembled. And each of the inserted rolling elements is rotatable within a groove space formed between the bearing rings by providing a small groove in the raceway groove, even when the bearing rings are the monolithic type. Also, one side of the retainer pocket in the axial direction is opened, and the rolling elements can be incorporated one side after another in a state where the inner and outer races and the retainer are assembled. With this retainer constitution, the axial guide face of the rolling element is decreased to one face as compared with two faces conventionally, whereby the force for restraining the rolling elements is reduced. Consequently, the friction on the end face produced between the retainer and the rolling elements is decreased greatly (about half) and the torque is reduced.

Also, to achieve the second object, technical approach of the invention is a direct drive motor having a structure in which a stator is disposed in at least one or both of the inside and the outside of a rotor, and a bearing is provided to support the rotation and load, in which the motor can be driven by directly connecting a load without using a speed reducer, characterized in that the bearing is the rolling bearing with the constitution as described above.

Moreover, a direct drive motor having a structure in which a stator is disposed in at least one or both of the inside and the outside of a rotor, and a bearing is provided to support the rotation and load, in which the motor is capable of driving a load by being directly connected to the load without using a speed reducer, characterized in that the bearing has a plurality of rolling elements incorporated between a pair of bearing rings, each of the bearing rings having a raceway groove composed of a raceway surface having a larger radius than the radius of the rolling elements, at least one of the bearing rings being composed of two raceway surfaces, in which each of the rolling elements has an outside diameter of a rolling contact face with a curvature in the axial direction, the rolling elements are disposed crosswise so that the central axes of rotation of the rolling elements are skewed alternately with each other in the circumferential direction of the bearing rings, and an outer peripheral face of each rolling element is always in point contact with a raceway surface of one of the bearing rings and a raceway surface of the other bearing ring, which are opposed to each other, at each one point, or at two points in total.

At this time, each of the rolling elements maybe an upper and lower cut ball having one set of opposing faces, in which the central axis of rotation of the rolling element is orthogonal to each opposing face. Moreover, each of the rolling elements is a one-side cut ball having a cut face, in which the central axis of rotation of the rolling element is orthogonal to the cut face.

### BRIEF DESCRIPTION OF THE DRAWINGS

FIG. 1 is a schematic cross-sectional view, partially omitted, showing a rolling bearing according to a first embodiment of the invention.

FIG. 2 is a schematic plan view, partially omitted, showing a direction of incorporating a rolling element into a retainer in the rolling bearing of the invention.

FIG. 3 is a perspective view showing one embodiment of the rolling element incorporated into the rolling bearing of the invention.

FIG. 4 is a perspective view showing another embodiment of the rolling element incorporated into the rolling bearing of the invention.

FIG. 5 is a perspective view showing another embodiment of the rolling element incorporated into the rolling bearing of the invention.

FIG. 6 is a schematic cross-sectional view, partially cut away, showing one embodiment of a direct drive motor incorporating the rolling bearing of the invention.

FIG. 7 is a chart showing the experimental results of the bearing torque and its variations for the bearing of this embodiment and the conventional bearing.

FIG. 8 is a cross-sectional view showing a rolling bearing according to a second embodiment of the invention.

FIG. 9 is a perspective view showing one embodiment of the rolling element.

FIG. 10 is a chart showing measurement data of a dynamic torque in the bearing simplex.

FIG. 11 is a cross-sectional view, partially cut away, showing a rolling bearing according to a third embodiment.

FIG. 12 is a cross-sectional view, partially cut away, showing a rolling bearing according to a fourth embodiment.

FIG. 13 is a cross-sectional view, partially cut away, showing a rolling bearing according to a fifth embodiment.

FIG. 14 is a longitudinal cross-sectional view, partially cut away, showing a rolling bearing according to a sixth embodiment.

FIG. 15 is an enlarged perspective view showing one embodiment of a separator.

FIG. 16 is a longitudinal cross-sectional view, partially cut away, showing a rolling bearing according to a seventh embodiment.

FIG. 17 is an enlarged perspective view showing another embodiment of the rolling element.

FIG. 18 is a longitudinal cross-sectional view, partially cut away, showing a rolling bearing according to an eighth embodiment.

FIG. 19 is a longitudinal cross-sectional view, partially cut away, showing a rolling bearing according to a ninth embodiment.

FIG. 20 is a longitudinal cross-sectional view, partially cut away, showing a rolling bearing according to a tenth embodiment.

FIG. 21 is a longitudinal cross-sectional view, partially cut away, showing a rolling bearing according to an eleventh embodiment.

FIG. 22 is a longitudinal cross-sectional view, partially cut away, showing a rolling bearing according to a twelfth embodiment.

FIG. 23 is an enlarged perspective view showing another embodiment of the retainer.

FIG. 24 is a longitudinal cross-sectional view, partially cut away, showing a rolling bearing according to a thirteenth embodiment.

FIG. 25 is an enlarged perspective view showing another embodiment of the rolling element.

FIG. 26 is an enlarged plan view, partially omitted, showing another embodiment of the retainer.

FIG. 27 is a cross-sectional view of the retainer of FIG. 26, taken along the line I-I.

FIG. 28 is a cross-sectional view showing another embodiment of the retainer.

FIG. 29 is an enlarged plan view, partially omitted, showing another embodiment of the retainer.

FIG. 30 is a cross-sectional view of the retainer of FIG. 29, taken along the line II-II.

FIG. 31 is an enlarged perspective view of a separator used in the thirteenth embodiment.

FIG. 32 is a longitudinal cross-sectional view, partially omitted, showing a rolling bearing according to a fourteenth embodiment.

FIG. 33 is a longitudinal cross-sectional view, partially omitted, showing a rolling bearing according to a fifteenth embodiment.

FIG. 34 is a longitudinal cross-sectional view, partially omitted, showing a rolling bearing according to a sixteenth embodiment.

FIG. 35 is a schematic cross-sectional view, partially cut away, showing a conventional direct drive motor.

FIG. 36 is a longitudinal cross-sectional view of a crossed roller bearing.

FIG. 37 is a schematic cross-sectional view, partially omitted, showing a conventional rolling bearing.

FIG. 38 is a schematic plan view, partially omitted, showing a direction of incorporating a rolling element into the retainer in the conventional rolling bearing.

In the figures, reference sign A denotes a rolling bearing, 1 denotes an outer race, 2 denotes an inner race, 3 denotes a raceway groove, 4 denotes a groove (for rotation), 5 denotes a rolling element, 5a denotes an outside diameter, 5b denotes a planar portion, 5f denotes a connecting portion, 6 denotes a retainer, 7 denotes a pocket, 7b denotes an axial pocket face, B denotes a rolling bearing, 101 denotes an outer race, 102 denotes an inner race, 103 denotes a raceway groove, 105 denotes a rolling element, 105a denotes an outside diameter, 105b denotes a opposing face, 105c denotes a central axis of rotation, 17 denotes a rotor, 18 denotes a stator, 19 denotes a pulsar ring, 20 denotes a position transducer, and 21 denotes a coil.

### BEST MODE FOR CARRYING OUT THE INVENTION

A first embodiment of the present invention will be described below with reference to the accompanying drawings. This embodiment is only illustrative of this invention, and not construed to be limited in this invention, in which various changes in design may be made within the scope of the invention.

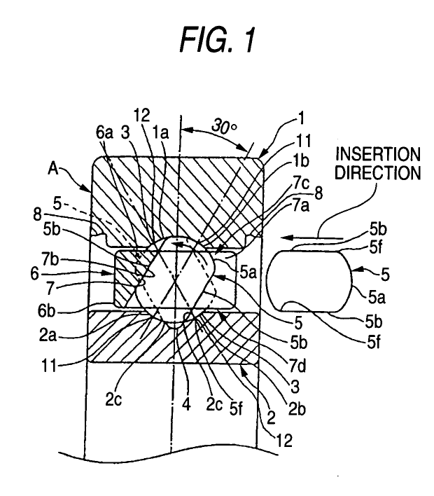

A rolling bearing A has a plurality of rolling elements 5, 5 . . . incorporated via a retainer 6 in a raceway groove 3 formed in an inside diameter of a bearing ring (bearing outer race) 1 monolithically molded and an outside diameter of a bearing ring (bearing inner race) 2 monolithically molded, as shown in FIG. 1. In FIG. 1, reference numeral 8 denotes a seal groove. In this embodiment, a sealed plate (seal•shield) is omitted in the figure, but the sealed plate may be appropriately provided, as needed. The constituents such as the size of bearing, contact angle, rolling element diameter and material are not limited.

According to this embodiment, since the outer race 1 and the inner race 2 as the bearing rings are monolithically molded, the manufacturing cost, assembling management and assembling cost of the bearing rings, including the related parts such as a fastening bolt, are greatly reduced.

The raceway groove 3 is composed of the raceway surfaces 1a-1b, 2a-2b having a larger radius than the radius of the rolling element 5.

Also, the raceway surfaces may be appropriately selected within the scope of the invention, as long as the raceway groove for at least one of the bearing rings is constituted of two raceway surfaces.

The shape of each raceway surface 1a, 1b, 2a, 2b may be arbitrary such as arcuate or V-character in cross section, as long as it is suitable for rolling of the rolling element 5. Also, it may be curvilinear or linear, and is not specifically limited, but a so-called Gothic arch formed of both circular arcs with the circle centers disposed crosswise in this embodiment.

And a smaller groove 4 than the raceway groove 3 is cut in a part of the raceway groove 3 of the inner race 2.

In this embodiment, the smaller groove (e.g., radius of groove of about 0.8 mm) has a semicircular cross section and a desired depth and is continuous circumferentially in the center of the raceway groove 3 composed of the raceway surfaces 2a, 2b of the inner race. This groove 4 is principally employed as the groove for rotation in incorporating the rolling element 5. That is, a connection portion (intersection) 5f between a rolling contact face 5a and a planar portion 5b for the rolling element 5 to be described later is inserted into the groove 4 at the time of incorporation to make the rolling element 5 rotatable within a space of the raceway groove 3. A lubricant may be carried in the groove 41 and a stable bearing life is expected as an action with a lubricant holding function for lubricant (oil, grease, etc.) provided on the raceway surface.

The shape, radial depth and axial width of the groove 4 are preferably of the minimum size to make the raceway surface as large as possible. However, if the connecting portion 5f between the rolling contact face 5a and the planar portion 5b for the rolling element 5 is partly insertable into the groove 4, they are all within the scope of the invention, and not specifically limited to the illustrated embodiment, in which various variations in design may be made within the scope of the invention. For example, an angle of chamfer of about 45 degrees may be made.

Also, in view of an interval at which the rolling elements 5 are disposed circumferentially, the groove 4 may be provided intermittently with a desired length in the circumferential direction, which is within the scope of the invention.

A connecting portion 2c between the raceway surfaces 2a, 2b may be formed in the shape of R by eliminating the edge thereof.

This groove 4 is only provided in the raceway groove 3 of the inner race 2 in this embodiment, as described above, but may be provided in the raceway groove 3 of the outer race 1, or in both the outer race 1 and the inner race 2.

The rolling element 5 has the outside diameter 5a as a rolling contact face with a curvature in the axial direction, and an arbitrary shape having a smaller radius than the radius of each raceway surface 1a, 1b, 2a, 2b. The rolling elements 5 are arranged alternately crosswise to adjacent rolling elements 5, and the outside diameter 5a of each rolling element 5 is always contact at two points with the raceway surface 1a, 1b of one bearing ring 1 and the raceway surface 2a, 2b of the other bearing ring 2.

The rolling element 5 is an upper and lower cut ball (with a structure in which the upper and lower portions of a ball are cut away to form the planar portions 5a, 5b, the same in the following specification) having one set of planar portions (opposing faces) 5a, 5b in this embodiment, for example, as shown in larger scale in FIG. 3. The rolling elements 5, 5, . . . are incorporated so that the rotation axes of rotation 5c perpendicular to the planer portions 5b, 5b may be crossed with each other, and the outside diameter 5a of each rolling element 5 is always contact at two points with the raceway surface 1a, 1b of one bearing ring 1 and the raceway surface 2a, 2b of the other bearing ring 2. In the figures, 5f denotes the connecting portion (intersection) between the rolling contact face 5a and the planer portion 5b of the rolling element 5.

The upper and lower cut widths of the rolling element 5 are not specifically limited, and the ratio of upper and lower cut widths may or may not be even, and arbitrarily settable within the scope of the invention. That is, though the planar portions 5b, 5b are symmetrical in this embodiment, the planar portions 5b, 5b of the rolling element 5 may be symmetrical or asymmetrical, which is within the scope of the invention.

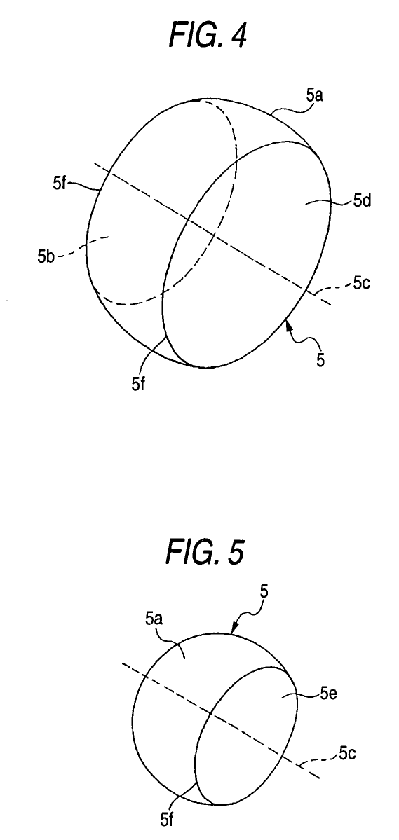

Also, in the rolling element (upper and lower cut ball) 5 having the asymmetrical planar portions 5b, 5d as shown in FIG. 4, a planar portion 5d at the larger end is disposed to face the inner race 2 of the bearing, whereby the rotation of the rolling element 5 is more stable and the lower torque is realized.

The overall shape of the rolling element 5, the presence or absence of the opposing faces 5b, 5b, and the magnitude of curvature in the axial direction of the outside diameter 5a are not limited to the above specifications, and may be arbitrarily changed within the scope of the invention. That is, for example, two non-parallel faces (planar portions) may be provided, instead of the planar portions 5b, 5b, with the central axis of rotation perpendicular to both the faces (not shown).

Also, the rolling element may be a one-side cut ball in which one side of a ball is cut away to provide one planar portion (cut face) 5e, as shown in FIG. 5.

Also, the planar portion 5b (5d, 5e) is arbitrary shape, and may be selectively changed to the optimal shape or size.

The rolling elements 5, 5, . . . are incorporated in such a way that the central axes of rotation 5c, 5c perpendicular to planar portions 5b-5b, 5b·5b in the adjacent rolling elements 5, 5 may be alternately crossed with each other. The state of intersection may or may not be orthogonal.

The manner in which the rolling elements 5 are disposed crosswise is not specifically limited, as long as the same number of rolling elements are disposed on both sides, in which the rolling elements 5 may not be circumferentially disposed alternately. That is, the rolling elements 5 may be crossed every one, or crossed every two, or every two, one, one and two, as long as the same number of rolling elements are disposed on both sides, all of which are within the scope of the invention.

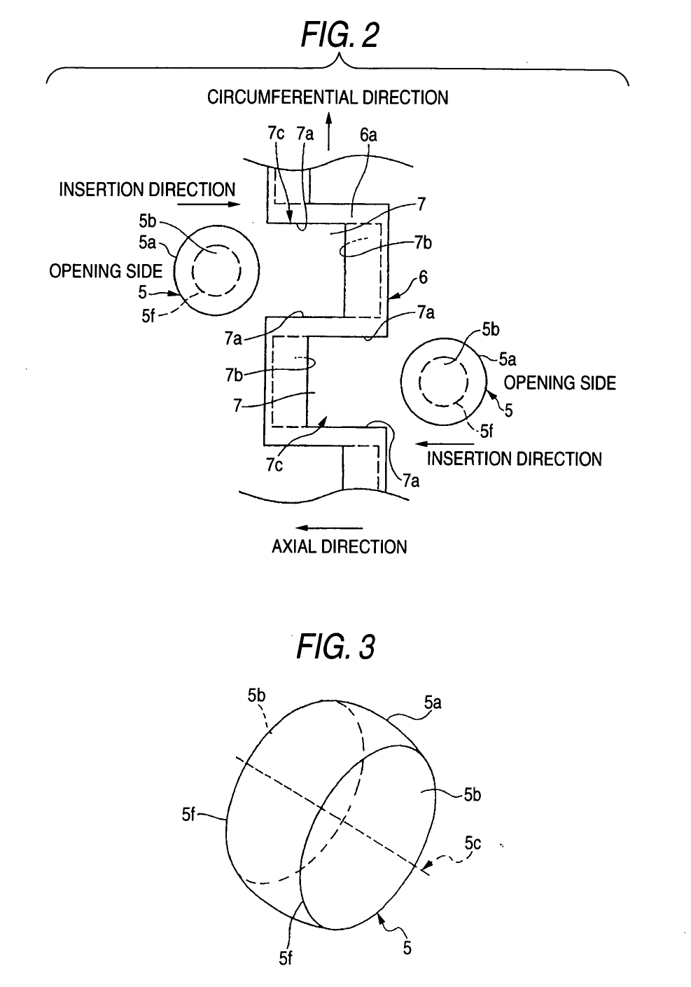

The motion of each rolling element 5, 5 is guided within the retainer 6 (see FIG. 2).

The retainer 6 is formed like an annulus ring in which a plurality of pockets (retaining portions) 7 for retaining and guiding the rolling element 5 are provided circumferentially, each pocket 7 having two pocket faces (circumferential guide faces) 7a, 7a opposed circumferentially, and only one pocket face 7b (axial guide face for axially stabilizing the attitude of the rolling element) in the axial direction, with an opposed face opened (open face). The axial pocket faces 7b are arranged inclinedly on the opposite side to each other in the axial direction, corresponding to a direction of inclination of the rolling elements 5 incorporated crosswise to each other. The shape of the circumferential pocket faces 7a is not specifically limited, but may be arbitrary.

The axial pocket face 7b is formed inclinedly from an outside diameter 6a to ah inside diameter 6b to guide the planar portion 5b (facing to the left upper direction in FIG. 1) on the opposite side of the outer race in the rolling element 5. Hence, an opening 7d of the inside diameter is larger than an opening 7c of the outside diameter in the pocket 7.

The angle of inclination of the pocket face 7b may be arbitrary, and is decided in view of the angle of the rolling element 5 disposed within the space of the raceway groove 3.

In this embodiment, the axial pocket faces 7b of the pockets 7 that are provided at an equal interval on the circumference of circle, corresponding to the number of rolling elements 5, and are adjacent in the circumferential direction, are disposed alternately crosswise in the circumferential direction, allowing adjacent rolling elements 5, 5 to be incorporated alternately so that the central axes of rotation 5c, 5c perpendicular to the planar portions 5b•5b, 5b•5b maybe crossed with each other, as described above.

In this embodiment, the pockets 7 are arranged at an equal interval and alternately crosswise on the circumference of circle, corresponding to the number of rolling elements 5. However, the arrangement of the pockets 7 is not specifically limited, but the pockets may be arranged crosswise every two, or every two, one, one and two, as long as the number of pockets 7 is the same on both sides, all of which are within the scope of the invention. Hence, the retainer is provided with the pockets circumferentially in the above manner in which the rolling elements 5 are disposed.

The guiding method of the retainer 6 is not specifically limited, but may be an inner race guide, an outer race guide or a rolling element guide. Also, the constitution of the retainer 6 is of the monolithic type in this embodiment, but is not specifically limited, and may be formed of several parts.

In this embodiment, after the retainer 6 is assembled with the outer race 1 and the inner race 2, the rolling elements 5 are inserted successively from the opening side of the retainer 6 into the space of the bearing raceway groove 3.

In this embodiment, the rolling bearing is a preload product but may be a clearance product.

The state where a preload is applied between the rolling element and the raceway surface is not specifically limited, but the preload may or may not be applied at the manufacturing stage, which is within the scope of the invention.

The material of the bearing rings 1, 2 and the rolling element 5 for the bearing is usually ball-beating steel, but may be appropriately selected from stainless steel or ceramic to improve the corrosion resistance or heat resistance in the use environments.

Also, the retainer 6 is appropriately selected from a machined cage, a press retainer, and a resin retainer, and made of metal such as brass or iron, or synthetic resin such as polyamide 66 (nylon 66) or polyphenylene sulfide (PPS) within the scope of the invention.

In this embodiment, the outside diameter 5a of the rolling element 5 is in point contact with the raceway surface 1b of the outer race 1 and the raceway surface 2a of the inner race 2 which are opposed to each other (contact points being indicated by 11, 11), and the adjacent rolling elements 5 are in point contact with the raceway surface 1a of the outer race 1 and the raceway surface 2b of the inner race 2 (contact points being indicated by 12, 12). The rolling elements 5, 5 are crossed alternately at a contact angle, whereby one bearing can receive a radial bearing, a bidirectional axial bearing and a moment bearing.

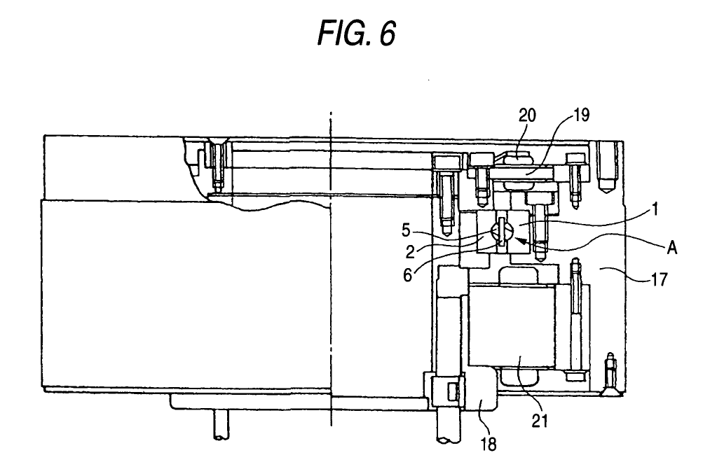

Moreover, the rolling bearing A of this embodiment is incorporated into the direct drive motor, as shown in FIG. 6, whereby the motor of this kind superior to the conventional motor can be provided.

FIG. 6 is a schematic view showing one embodiment of the direct drive motor. In FIG. 6, 17 denotes the rotor, 18 denotes the stator, and 21 denotes the coil. The rolling bearing A is incorporated between the rotor 17 and the stator 18. The rotor 17 and the pulsar ring 19 are rotated by energizing the coil 21, so that the position transducer 20 detects the convex or concave of the pulsar ring 19, and the rotation speed and positioning are controlled by a controller (not shown). In this embodiment, an outer rotor type in which the outside of the motor is rotated is employed, but an inner rotor type in which the inside of the motor is rotated may be employed without problem.

The bearing outer race 1 is fitted with the rotor 17, and secured with the pulsar ring 19. On the other hand, the bearing inner ring 2 is fitted with the stator 18 having the coil 21 wound, and secured with the position transducer 20.

The direct drive motor of this embodiment has the same well known constitution as the conventional direct drive motor, except for the component of the rolling bearing A, but is not specifically limited to the shown example, and may be appropriately changed in design to the other well known constitutions within the scope of the invention.

In this manner, the constitution of the bearing A contained in the direct drive motor is made the rolling bearing of the invention as described in the above embodiment, whereby the torque of bearing is reduced below that of the conventional crossed roller bearing, and the heating is suppressed. Also, the rigidity is obtained by applying a preload on the bearing. Accordingly, the high speed is enabled without hampering the function of the conventional direct drive motor.

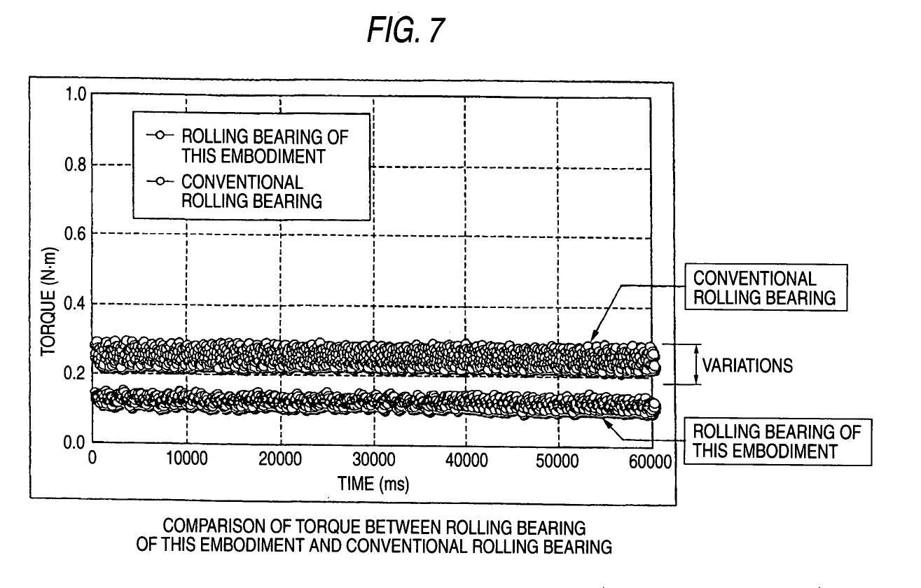

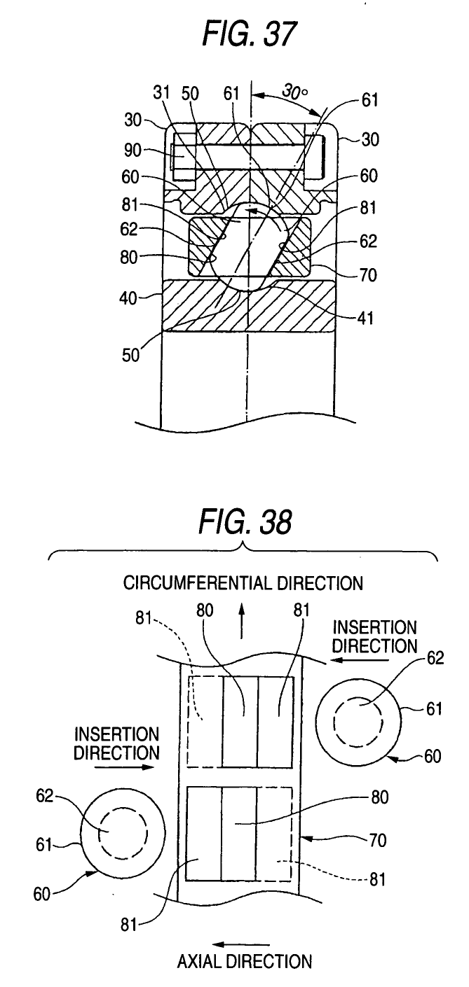

Herein, the experimental results of the bearing torque and its variations for the rolling bearing (embodiment product of FIG. 1) A of the first embodiment and the conventional rolling bearing (conventional product of FIG. 37) are shown in comparison in FIG. 7.
Test bearing: outside diameter φ90×inside diameter φ60×width 13
Number of rolling elements 28 (14 in each row)
Diameter of rolling element φ6.35
Width between planar portions 4 mm
Preload product with axial clearance—15 μm
Contact angle 30 degrees

According to the experimental results, it has been found that the bearing A of this embodiment has a lower torque than the conventional bearing (FIGS. 37 and 38). Also, it has been found that the variation of the bearing torque is smaller.

Alsp, because the test bearing at this time is the preload product, the rolling elements are all inserted into the groove, whereby the outer race is expanded by heating and assembled with a clearance.

It has been confirmed that the rolling elements may be directly pushed into the groove, employing a relative displacement between the inner and outer races of the rolling element without heating the outer race. Be careful not to damage the rolling contact face at the time of insertion.

Another embodiment of the direct drive motor of the invention will be described below with reference to the drawings. This embodiment is only one embodiment of this invention, but not construed to be limited in this invention.

The direct drive motor of this embodiment has the same well known constitution as the direct drive motor as shown in FIG. 6, except for the bearing component. In the following, the bearing constitution that is a characteristic portion of the invention will be described below in connection with the second to sixteenth embodiments. The constitution except for the bearing component of the direct drive motor is not specifically limited to the shown example, but may be appropriately changed in design to other well known constitutions within the scope of the invention.

### Second Embodiment

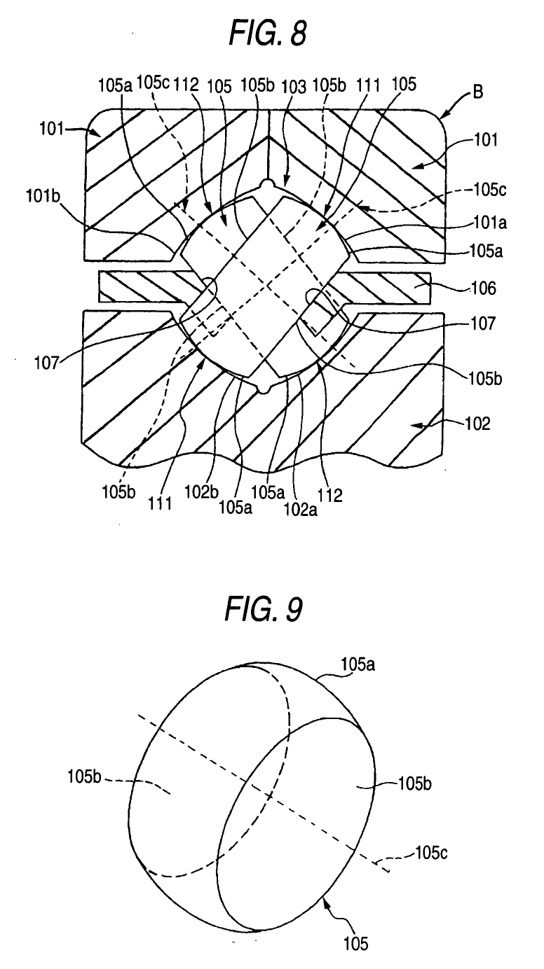

A rolling bearing A for use in a second embodiment is constituted by incorporating a plurality of rolling elements 105, 105, . . . into a raceway groove 103 formed between an inside diameter of a bearing ring (bearing outer race) 101 and an outside diameter of a bearing ring (bearing inner race) 102, as shown in FIG. 8. And the bearing outer race 101 is fitted with the rotor 17, and secured with the pulsar ring 19. And the bearing inner race 102 is fitted with the stator 18 having the coil 21 wound, and secured with the position transducer 20.

The rolling bearing A is formed with the raceway groove 103 of a desired shape by the raceway surface formed between the inside diameter of one bearing ring (outer race) 101 and the outside diameter of the other bearing ring (inner race) 102. In this embodiment, the bearing ring (outer race) 101 is axially divided into two centrally in the width direction, and the bearing ring (inner race) 102 is monolithic.

It is within the scope of the invention that at least one or both of the bearing rings 101, 102 may be axially divided into two centrally in the width direction, or none of the bearing rings 102, 102 may be divided. Also, in the two division type, the bearing rings are assembled together by a bolt and a rivet.

The raceway groove 103 is formed by the raceway surfaces 101a•101b, 102a•102b having a larger radius than the radius of the rolling elements 105. Also, it is only necessary that the raceway groove of at least one of the bearing rings is made up of two raceway surfaces within the scope of the invention.

The shape of the raceway surfaces 101a•101b, 102a•102b is not specifically limited, such as arcuate or V-character in cross section, or curvilinear or linear, as long as it is appropriate for rolling of the rolling elements 105. In this embodiment, a Gothic arch may be applied, for example.

The rolling elements 105 has an outside diameter 105 as a rolling contact face with a curvature in the axial direction, and may have an arbitrary shape having a smaller radius than the radius of the raceway surfaces 101a-10b, 102a-102b. The rolling elements 105 are arranged alternately crossing with adjacent rolling elements 105, the outside diameter 105a of each rolling element 105 being always contact at two points with the raceway surface 101a, 101b of one bearing ring 101 and the raceway surface 102b, 102a of the other bearing ring 102.

The rolling element 105 is an upper and lower cut ball (with a structure in which the upper and lower portions of ball are cut away to form the opposing faces 105b, 105b, the same in the following specification) having one set of opposing faces 105a, 105b in this embodiment, for example, as shown in FIG. 9. The rolling elements 105, 105, . . . are incorporated so that the rotation axes of rotation 105c perpendicular to the opposing faces 105b, 105b may be crossed, and the outside diameter 105a of each rolling element 105 is always contact at two points with the raceway surface 101a, 101b of one bearing ring 101 and the raceway surface 102a, 102b of the other bearing ring 102.

The upper and lower cut widths of the rolling element 105 are not specifically limited, but the ratio of upper and lower cut widths may or may not be even, and arbitrarily settable within the scope of the invention. That is, though the opposing faces 105b, 105b are symmetrical in this embodiment, the opposing faces 105b, 105b of the rolling element 105 may be symmetrical or asymmetrical, which is within the scope of the invention.

The overall shape of the rolling element 105, the presence or absence of the opposing faces 105b, 105b, and the magnitude of curvature in the axial direction of the outside diameter 105a are not limited to the above specific configurations, and may be arbitrarily changed within the scope of the invention. That is, for example, two non-parallel faces may be provided, instead of the opposing faces 105b, 105b, with the central axis of rotation 105c perpendicular to both the faces. Also, the rolling element 105 may be a one-side cut ball in which one side of a ball is cut away to provide one planar portion (cut face).

The rolling elements 105, 105, . . . are incorporated in such a way that the central axes of rotation 105c, 105c perpendicular to opposing faces 105b•105b, 105b•105b of adjacent rolling elements 105, 105 may be alternately crossed. The state of intersection may or may not be orthogonal.

The manner in which the rolling elements 105 are disposed crosswise is not specifically limited, as long as the same number of rolling elements are disposed on both sides. That is, the rolling elements 105 may be crossed every one, or crossed every two, or every two, one, one and two, as long as the same number of rolling elements are disposed on both sides, which are within the scope of the invention.

The motion of each rolling element 105, 105 is guided within a retainer 106.

The retainer 106 is not specifically limited, as long as it has a shape having a retaining portion 107, . . . for retaining and guiding the rolling element 105, and may be arbitrarily changed within the scope of the invention.

The guiding method of the retainer 106 is not specifically limited, but may be an inner race guide, an outer race guide or a rolling element guide. Also, the constitution of the retainer 106 is not specifically limited, but may be of the monolithic type or formed of several parts.

For example, the retainers 106 have the retaining portions 107, 107, . . . formed alternately in the circumferential direction and incorporated alternately so that the central axes of rotation 105c, 105c perpendicular to the opposing faces 105b•105b, 105b•105b are crossed with each other for adjacent rolling elements 105, 105.

The state where a preload is applied between the rolling element and the raceway surface is not specifically limited. That is, the preload may or may not be applied at the manufacturing stage, which is within the scope of the invention.

The material of the bearing rings 101, 102 and the rolling elements 105 for the bearing is usually ball-bearing steel, but may be appropriately selected from stainless steel and ceramic to improve the corrosion resistance or heat resistance in the use environments.

Also, the retainer 6 is appropriately selected from a machined cage, a pressed retainer, and a resin retainer, and made of metal such as brass or iron, or synthetic resin such as polyamide 66 (nylon 66) or polyphenylene sulfide (PPS) within the scope of the invention.

In the second embodiment, the outside diameter 105a of the rolling element 105 is in point contact with the raceway surface 101a of the outer race 101 and the raceway surface 102b of the inner race 102 which are opposed to each other (contact points being indicated by 111, 111), and the adjacent rolling elements 105 are in point contact with the raceway surface 101b of the outer race 101 and the raceway surface 102a of the inner race 102 (contact points being indicated by 112, 112). The rolling elements 105, 105 are crossed alternately at a contact angle, whereby one bearing can receive a radial load, a bidirectional axial load and a moment load.

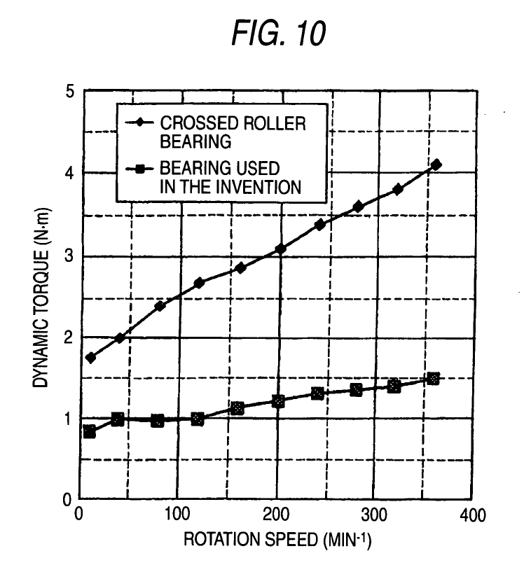

FIG. 10 shows measurement data of the dynamic torque in the bearing simplex. In FIG. 10, a lozenge part painted in black indicates the crossed roller bearing (conventional product), and a rectangular part with net indicates the rolling bearing for use in this invention.
Test bearing: inside diameter φ120×outside diameter φ170×width 25
Load condition: moment load 162N.m

As will be clear from this data, with the constitution of the rolling bearing according to the invention, the torque of the bearing is smaller than that of the conventional crossed roller bearing.

Accordingly, a contact state between the rolling element and the bearing ring is point contact, so that the contact width is smaller, the torque is smaller, and the heating is suppressed, whereby the use rotation speed range is wider. Moreover, the rigidity is obtained by applying a preload on the bearing. Hence, the high speed is enabled without hampering the function of the conventional direct drive motor.

### Third Embodiment

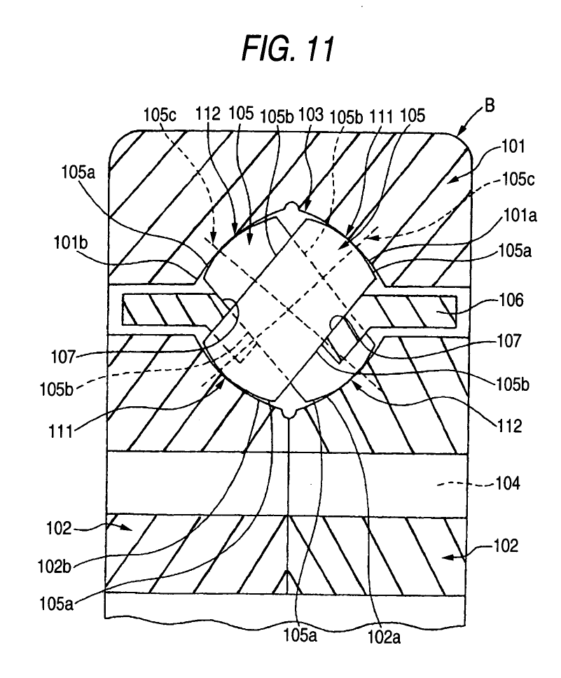

FIG. 11 shows a third embodiment. In this embodiment, the outer race 101 is monolithically formed, and the inner race 102 is divided into two, two divided inner races 102, 102 are secured by a bolt or rivet 104, whereby it is unnecessary to make adjustment for the preload or clearance. The other constitution and action are the same as in the second embodiment.

### Fourth Embodiment

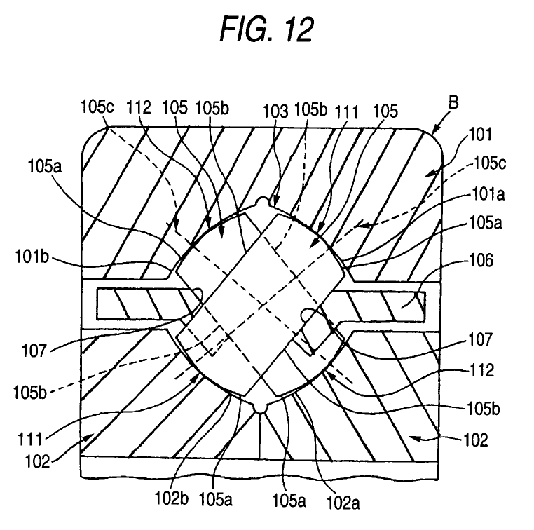

FIG. 12 shows a rolling bearing according to a fourth embodiment. In this embodiment, the outer race 101 is monolithically formed, and the inner race 102 is divided into two, instead of the constitution that the outer race 101 is divided into two and the inner race 102 is monolithically formed in the second embodiment. The other constitution and action are the same as in the second embodiment.

### Fifth Embodiment

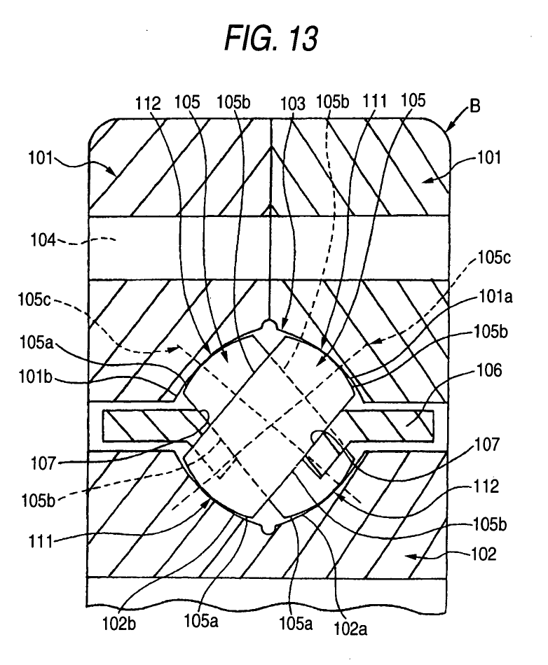

FIG. 13 shows a rolling bearing according to a fifth embodiment. In this embodiment, the divided outer races 101, 101 of the second embodiment are secured by the bolt or rivet 104, whereby it is unnecessary to make adjustment for the preload or clearance. The other constitution and action are the same as in the second embodiment.

### Sixth Embodiment

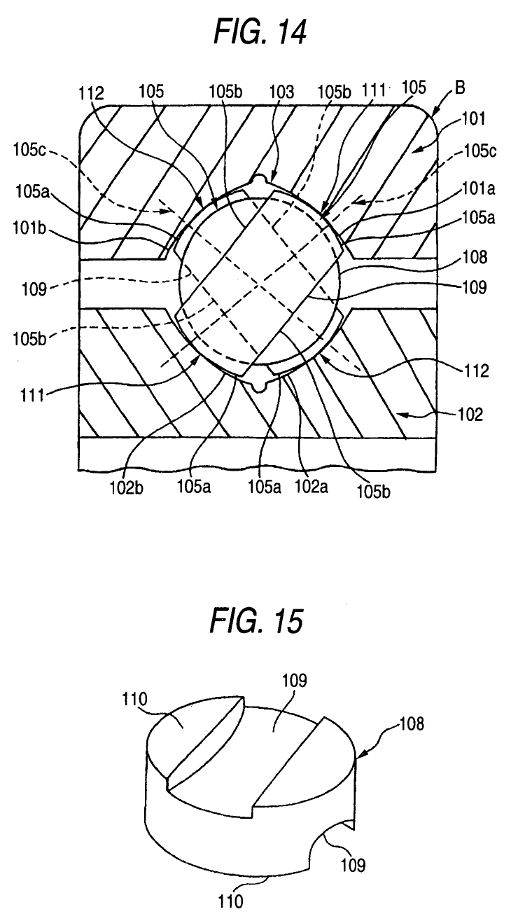

FIG. 14 shows a rolling bearing according to a sixth embodiment. In this embodiment, each of the outer race 101 land the inner race 102 is monolithically formed, with a rolling element receiving hole provided in the outer race 101. Also, a separator (spacer) 108 as shown in larger scale in FIG. 15 is provided, instead of the retainer 106 in the second embodiment, to guide the rolling elements 105, 105.

This constitution enables to further downsize the bearing.

The other constitution and action are the same as in the second embodiment.

The separator 108 has a smaller diameter than that of the rolling element 105, in which concave circular grooves 109, 109 are formed crosswise to the opposing faces 110, 110 to retain adjacent rolling elements 105, 105 so that the central axes of rotation 105c, 105c perpendicular to the opposing faces 105b•105b, 105b•105b may be crossed with each other, as described above.

The curvature of this circular groove 9 may be almost equal to or larger than that of the outside diameter 105a of the rolling element.

### Seventh Embodiment

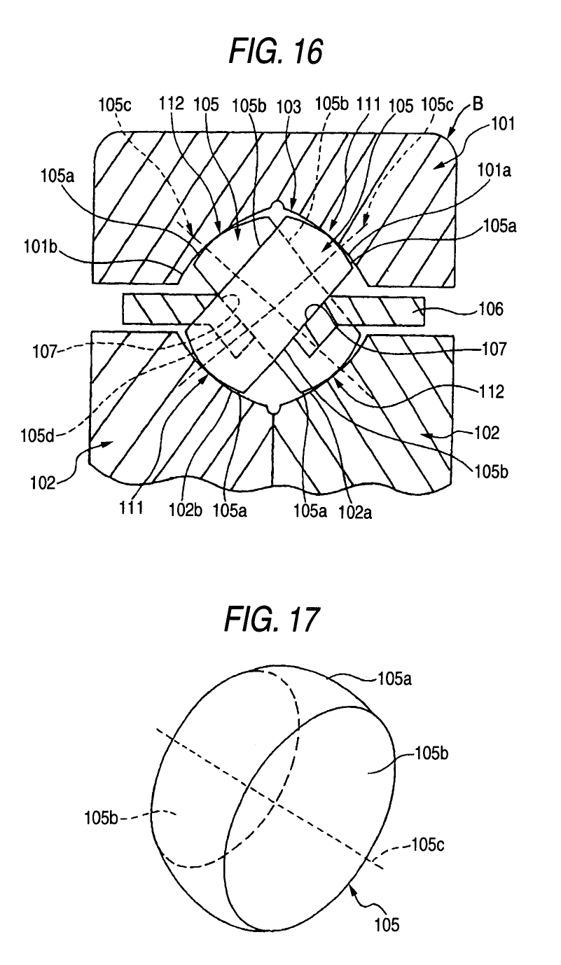

FIG. 16 shows a rolling bearing according to a seventh embodiment. In this embodiment, instead of the rolling elements 105 having the symmetrical opposing faces 105b, 10b in the fourth embodiment, the rolling elements (upper and lower cut balls) 105 having the asymmetrical opposing faces 105b, 105b as shown in FIG. 17 are employed, and a opposing face 105d on the large end is directed to the inner race 102 of the bearing, whereby the rotation of the rolling element 105 is stabilized to realize the lower torque.

The other constitution and action are the same as in the fourth embodiment.

### Eighth Embodiment

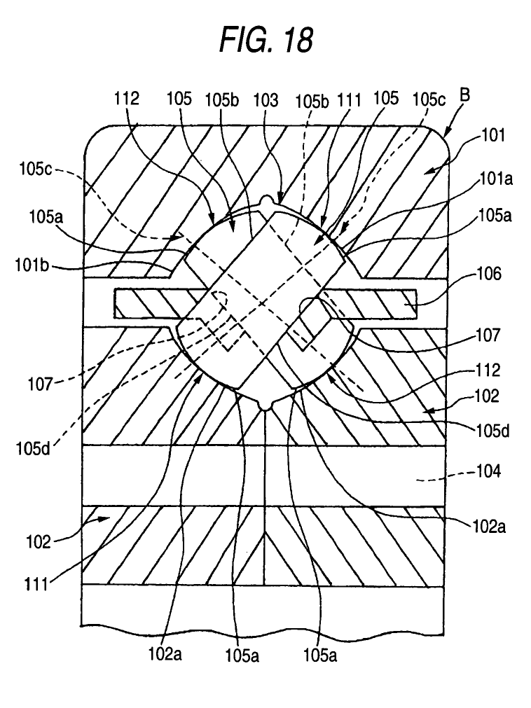

FIG. 18 shows a rolling bearing according to an eighth embodiment. In this embodiment, the divided inner races 102, 102 of the seventh embodiment are secured by the bolt or rivet 104, whereby it is unnecessary to make adjustment for the preload or clearance. The other constitution and action are the same as in the seventh embodiment.

### Ninth Embodiment

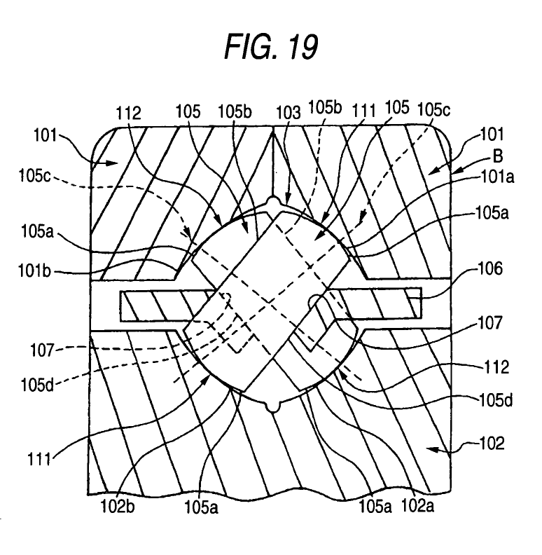

FIG. 19 shows a rolling bearing according to a ninth embodiment. In this embodiment, the two divided outer races 101, 101, and the monolithic inner race 102 are provided, instead of the constitution of the monolithic outer race 101, 101 and the two divided inner races 102, 102 in the seventh embodiment. The other constitution and action are the same as in the seventh embodiment.

### Tenth Embodiment

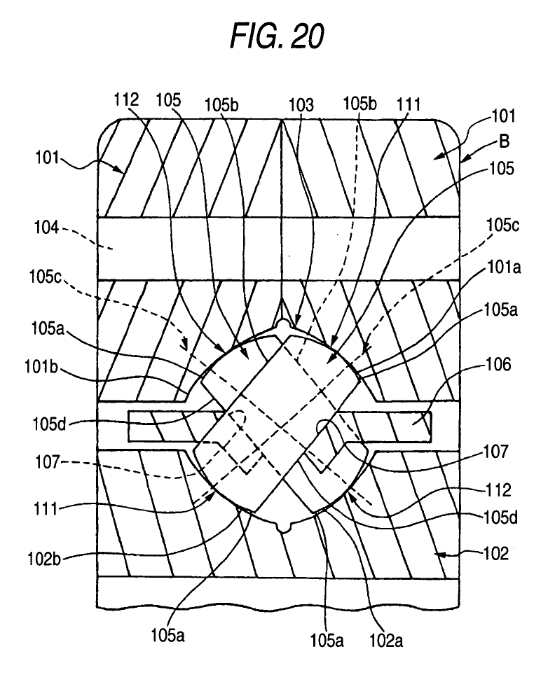

FIG. 20 shows a rolling bearing according to a tenth embodiment. In this embodiment, the two divided outer races 101, 101 of the ninth embodiment are secured by the bolt or rivet 104, whereby it is unnecessary to make adjustment for the preload or clearance. The other constitution and action are the same as in the seventh embodiment.

### Eleventh Embodiment

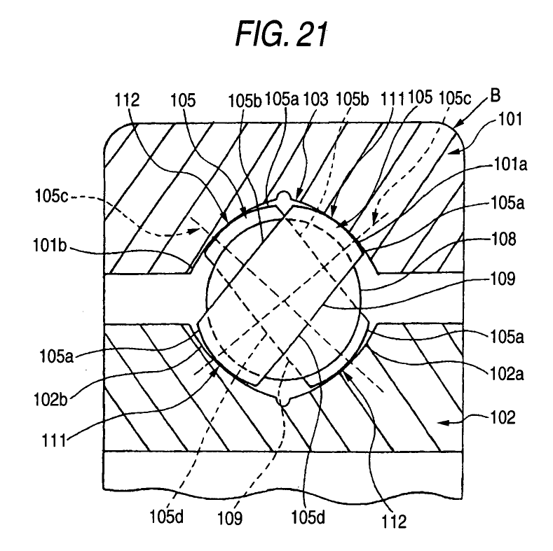

FIG. 21 shows a rolling bearing according to an eleventh embodiment. In this embodiment, a separator (spacer) 108 as shown in FIG. 15 is provided, instead of the retainer 106 in the second embodiment, to guide the rolling elements 105, 105. With this structure, the bearing is made more compact.

The other constitution and action are the same as in the second embodiment.

### Twelfth Embodiment

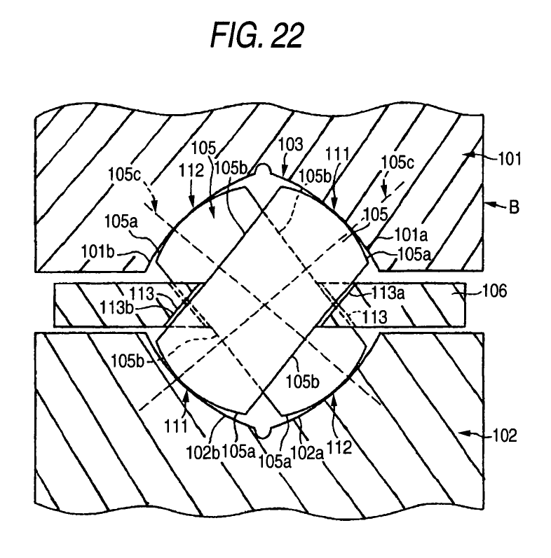

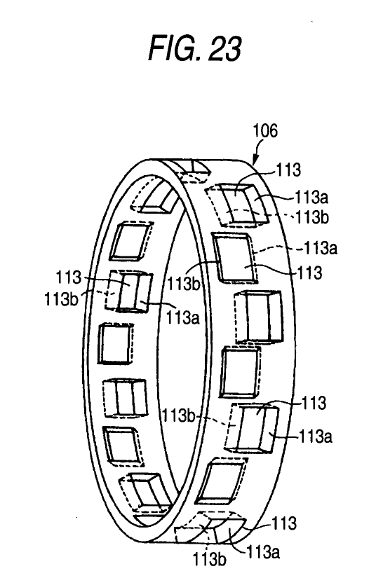

FIGS. 22 and 23 show a rolling bearing according to a twelfth embodiment. In this embodiment, a machined cage (annular retainer) 106 as shown in FIG. 23 is employed, instead of the retainer 106 of the second embodiment. The attitude of each rolling element 105 is kept by the retainer 106.

The retainers 106 have the retaining portions (pockets) 113, . . . for incorporating alternately adjacent rolling elements 105, 105 so that the central axes of rotation 105c, 105c perpendicular to the opposing faces 105b•105b, 105b•105b may be crossed with each other, in which the retaining portions 113, . . . are disposed alternately and crosswise at an equal interval, corresponding to the number of rolling elements 105, on the circumference of annular ring.

Both the side faces 113a, 113b of each retainer 113 in the axial direction are parallel to each other, neither perpendicular nor parallel to the rotation axis of bearing, and made at a certain angle (inclination) equivalent to the contact angle of the rolling element 105.

The distance between the side faces 113a, 113b of each retainer 113 is slightly larger than the width of the rolling element 105.

If the shape of the retainer 113 has the inclined and parallel side faces 113a, 113b, with the distance between the side faces 113a, 113b being slightly larger than the width of the rolling element 105, the overall shape of the pocket is not specifically limited, but may be changed within the scope of the invention.

In this embodiment, the pockets 113 are disposed alternately and crosswise at an equal interval on the circumference of circle, corresponding to the number of rolling elements 105, but not specifically limited thereto. The pockets 113 may be crossed every two, or every two, one, one and two, as long as the same number of pockets are disposed on both sides, which is within the scope of the invention.

The rolling element during rotation may possibly cause a spin or skew under the influence of various factors. The rotation resistance of the bearing is increased, or the rolling element cannot be possibly rotated smoothly, unless the attitude of the rolling element is excellently controlled.

Accordingly, the pocket 113 of the retainer 106 has the parallel side faces 113a, 113b inclined at a certain angle almost equivalent to the contact angle of the rolling element 105, and a change in the attitude of the rolling element 105 due to a spin or skew of the rolling element 105 is suppressed by the side faces 113a, 113b of the pocket, keeping the attitude of the beating, and the realizing the lower torque of the bearing in this embodiment.

The other constitution and action are the same as in the second to fifth embodiments and the seventh to tenth embodiments.

### Thirteenth Embodiment

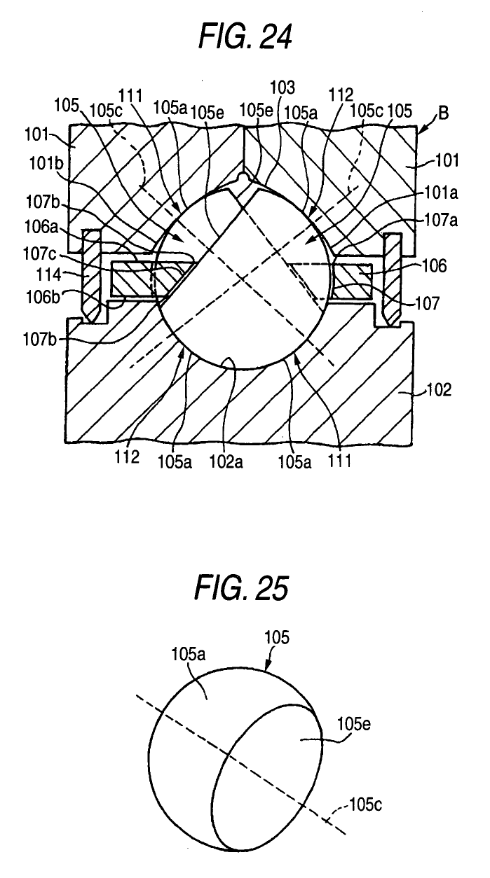

FIG. 24 shows a rolling bearing according to a thirteenth embodiment.

In this embodiment, the outer race 101 is divided into two and has two raceway surfaces 101a, 101b, and the inner race 102 is monolithically formed and has one raceway surface 102a, in which the rolling element is a one-side cut ball as shown in FIG. 25. In the embodiment, a Gothic arch composed of two raceway surfaces 101a, 101b having a larger radius than the radius of the rolling element 105 is employed, as described above. In the figure, reference numeral 14 denotes a sealed plate (seal shield).

The tolling element 105 has the outside diameter 105a of a rolling contact face with a curvature in the axial direction, and has the shape of one-side cut ball having a smaller radius than the radii of the raceway surfaces 101a (101b), 102a on the bearing rings 101, 102.

The rolling elements 105 are arranged alternately crossing with adjacent rolling elements 105, the outside diameter 105a of each rolling element 105 being always contact at two points with the raceway surface 101a (101b) of one bearing ring 101 and the raceway surface 102a of the other bearing ring 102

The rolling elements 105, 105, . . . are incorporated so that the rotation axes of rotation 105c perpendicular to the cut face 105e may be crossed with each other, and the outside diameter 105a of each rolling element 105 is always contact at two points with the raceway surface 101a (101b) of one bearing ring 101 and the raceway surface 102a of the other bearing ring 102.

The cut width of the cut face 105e for the rolling element 105 is not specifically limited, and the shape of the cut face 105e is not specifically limited to the flat face, and may be arbitrarily selected within the scope of the invention. Generally, for the rolling element of the same size, the ball has the lower cost and higher precision than the roller.

Though the manufacturing cost is lower as the shape of the rolling element is closer to the perfect ball, the rolling element 105 of this embodiment is the one-side cut ball, which has a smaller working portion and a lower manufacturing cost than the rolling element of the upper and lower cut ball.

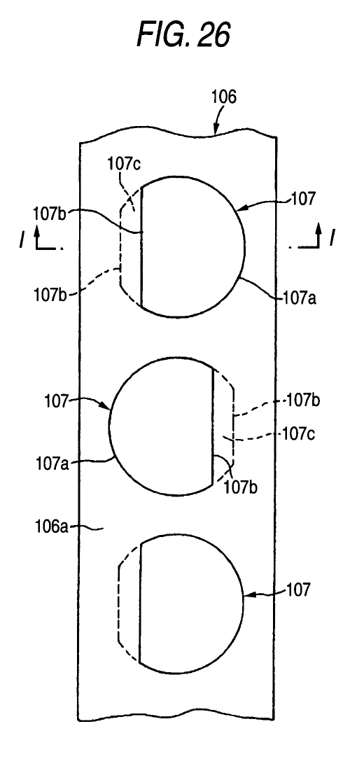

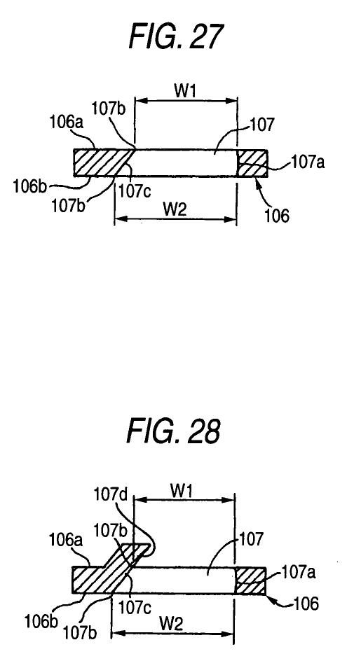

The retainer 106 have the retaining portions 107, 107, formed alternately in the circumferential direction and incorporated alternately so that the central axes of rotation 105c, 105c perpendicular to the cut faces 105e, 105e are crossed with each other for adjacent rolling elements 105, 105, as shown in FIG. 2t. The retaining portion 107 is formed line a dome in plan view by a circular face 107a having a slightly larger diameter than the rolling element, and a flat face (inclined face) 107c connecting the ends of the circular face 107a, in which one side 107b of the outside diameter 106a and one side 107b of the inside diameter 106b are communicated via the flat face 107c from the outside diameter 106a to the inside diameter 106b, and the opening width w2 of the inside diameter 106b is larger than the opening width w1 of the outside diameter 106a (FIGS. 26 and 27).

And the center of the circular faces 107a in the retainers 107 adjoining in the circumferential direction is placed on the same circumference of circle, and one side 107b of the outside diameter 106a is shifted in position in the width direction in plan view. That is, the pockets 107 adjoining in the circumferential direction have the inclined faces 107c disposed alternately to the left and right for each retainer 107 (see FIG. 26).

Accordingly, if the retainer 106 according to this embodiment is employed, the rolling element 105 disposed in each retainer 107 is retained to direct the cut faces 105e, 105e to the outside diameter 106a, namely, to the outer race 101, so that the central axes of rotation 105c, 105c of adjacent rolling elements 105, 105 are crossed with each other.

Also, it is possible to adopt a structure in which a one-side tripping bracket 107d inclinedly formed to stand on the outside diameter 106a is provided on the extension line of the flat face 107c, as shown in FIG. 28. The tripping bracket 107d is not specifically limited to the shape as shown, and within the scope of the invention, if the rotation of the rolling element 105 is not affected.

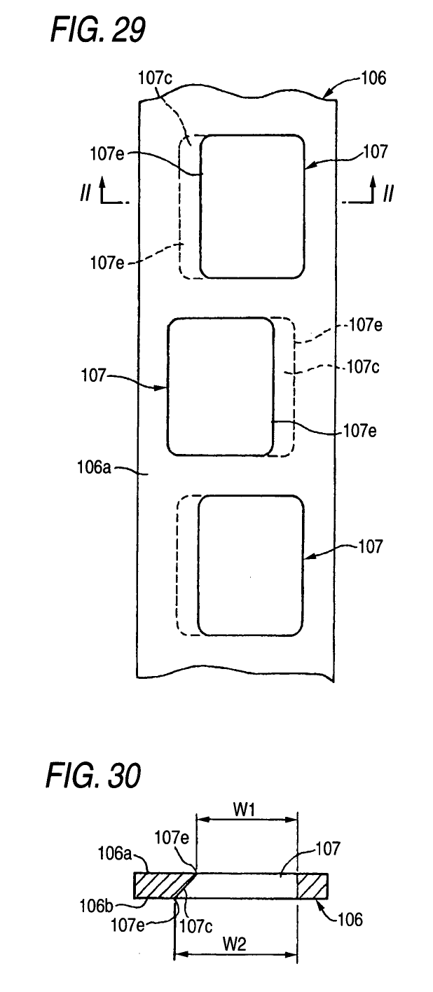

Also, it is possible to adopt a structure of the retainer 106 as shown in FIGS. 29 and 30.

In the embodiment as shown, the retainer 107 is made rectangular in plan view, in which one side 107e of the outside diameter 106a extending in the circumferential direction and one side 107e of the inside diameter 106b under it are communicated via the flat face 107c from the outside diameter 106a to the inside diameter 106b, and the opening width w2 of the inside diameter 106b is larger than the opening width w1 of the outside diameter 106a.

And the retainers 107 disposed in the circumferential direction are displaced alternately in the width direction in plan view. That is, the retainers 107 adjoining in the circumferential direction have the flat faces 107c disposed alternately to the left and right for each retainer 107 (see FIG. 29). The retainer 106 of this embodiment occupies a larger grease carrying space than the retainer 106 as shown in FIG. 26.

The other constitution and action are the same as the retainer as shown in FIG. 26.

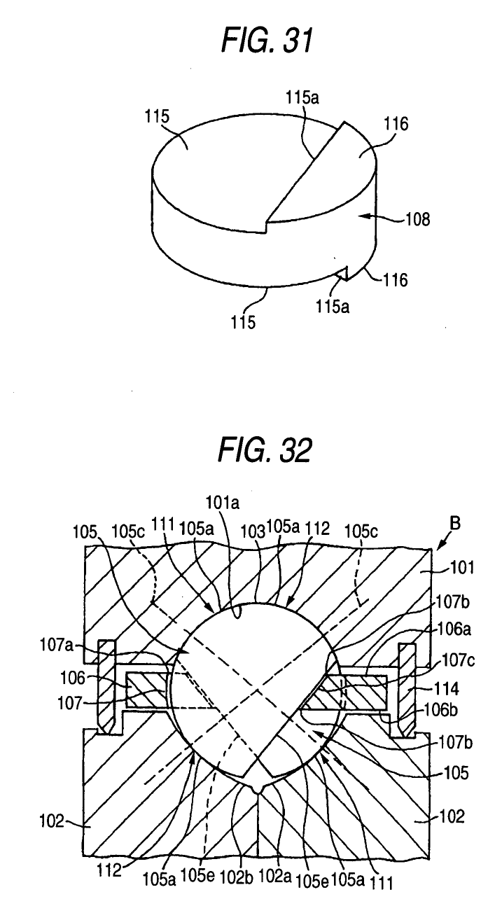

Also, the separator (spacer) 108 having a concave face 115 as shown in FIG. 31 maybe within the scope of the invention.

The separator 108 has a smaller diameter than the diameter of the rolling element 105, and has the concave faces 115, 115 formed crosswise to the opposing faces 116, 116 to retain the rolling elements 105, 105 so that the central axes of rotation 105c, 105c perpendicular to the cut faces 105e, 105e may be crossed with each other, as described above. That is, the concave faces retain the rolling elements by having the cut face 105e of the rolling element opposed to a step portion 115a of the concave face 115. The shape of the separator as shown in this embodiment is only one example, but not specifically limited, and may be arbitrarily changed in design.

Accordingly, in the thirteenth embodiment, when any kind of load such as a radial load, a bidirectional axial load, or a moment load is applied, the outside diameter 105a of the rolling element 105 is in point contact (contact points being indicated by 111, 111) with the raceway surface 101b of the outer race 101 and the raceway surface 102a of the inner race 102, which are opposed to each other. And the adjacent rolling elements 105 are in point contact (contact points being indicated by 112, 112) with the raceway face 101a of the outer race 101 and the raceway face 102a of the inner race 102.

Since the rolling elements 105, 105 are crossed with each other at A contact angle, one bearing can receive the radial load, bidirectional axial load and moment load.

Since the contact form between the rolling elements 105, 105 and the outer and inner races 101, 102 is the same as the typical ball bearing, the rolling element has a lower rolling resistance and a lower torque than the crossed roller.

### Fourteenth Embodiment

FIG. 32 shows a rolling bearing according to a fourteenth embodiment.

In this embodiment, the outer race 101 is monolithically formed and has one raceway surface 101a, and the inner race 102 is divided into two, and has two raceway faces 102a, 102b. The rolling elements 105 are disposed alternately crosswise on the circumference of circle so that the cut face 105e is directed to the inner race 102.

Accordingly, when any kind of load such as a radial load, a bidirectional axial load, or a moment load is applied, one of the adjacent rolling elements 105 is in point contact with the raceway surface 101a of the outer race and the raceway surface 102a of the inner race, which are opposed to each other, while the other of the adjacent rolling elements 105 is in point contact with the raceway surface 101a of the outer race and the raceway surface 102b of the inner race, which are opposed to each other.

The other constitution and action are the same as in the thirteenth embodiment.

In this embodiment, the shape of the retaining portion 107 of the retainer 106 is reversed from that used in the thirteenth embodiment (see FIG. 32).

That is, the retainer 106 is employed in the form in which the opening width w1 of the outside diameter 106a is larger than the opening width w2 of the inside diameter 106b, and the flat face 107c is directed to the outside diameter 106a.

Though the outer race 101 is not divided into two in this embodiment, the outer race 101 may be divided into two in this embodiment, or the inner race 102 may not be divided into two.

### Fifteenth Embodiment

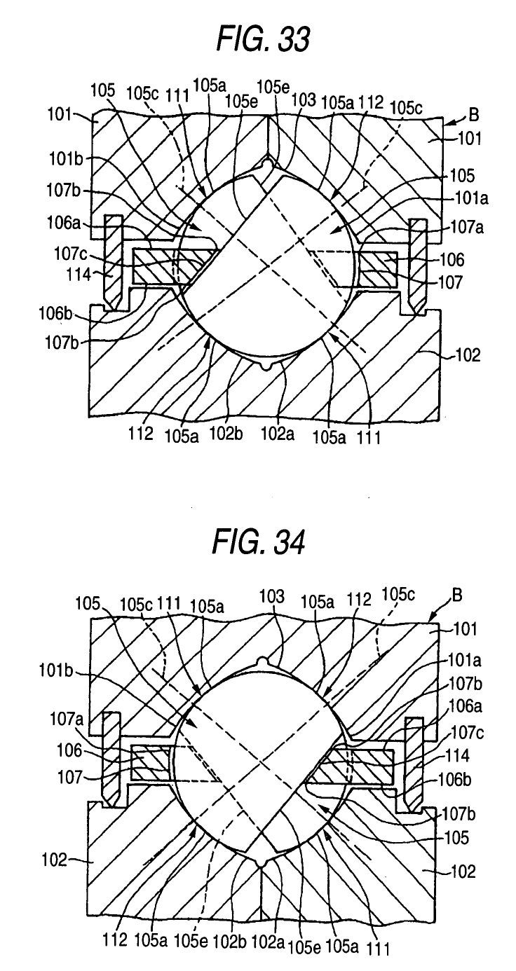

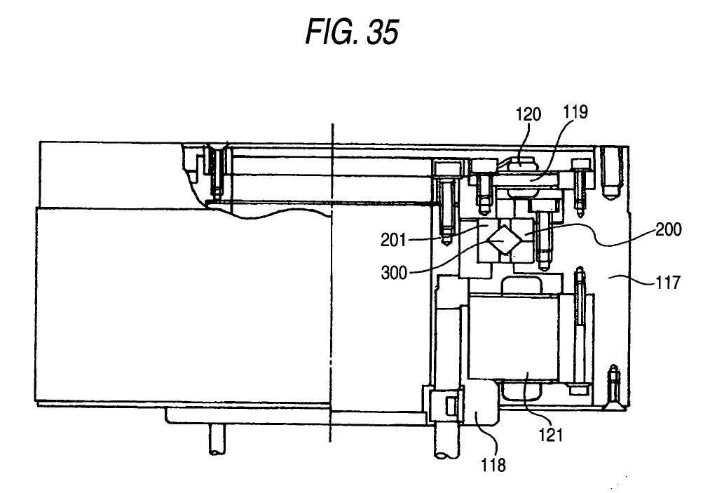

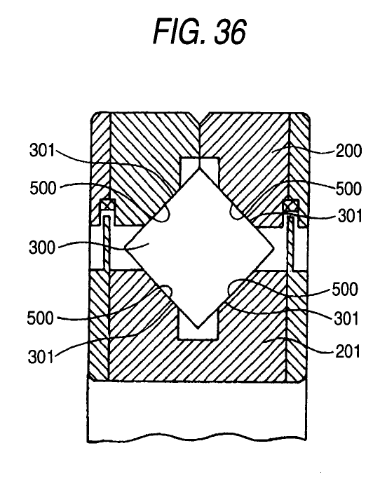

FIG. 33 shows a rolling bearing according to a fifteenth embodiment.

In this embodiment, the outer race 101 is divided into two and the inner race 102 is monolithically formed, each of the outer race and the inner race having two raceway surfaces 101a•101b, 102a•102b. The rolling elements 105 are disposed alternately crosswise on the circumference of circle so that the cut face 105e is directed to the outer race 101.

Accordingly, when an axial load or a moment load is applied, one of the adjacent rolling elements 105 is in point contact with the raceway surface 101a of the outer race and the raceway surface 102b of the inner race, which are opposed to each other, while the other of the adjacent rolling elements 105 is in point contact with the raceway surface 101b of the outer race and the raceway surface 102a of the inner race, which are opposed to each other. Also, when a radial load is applied the rolling element may be in contact at a total of three points with the bearing rings under the load condition in some cases.

The other constitution and action are the same as in the thirteenth embodiment, except that the inner race 102 has two raceway faces 102a, 102b. Though the inner race 102 is not divided into two in this embodiment, the inner race 102 may be divided into two, or the outer race 101 may not be divided into two.

### Sixteenth Embodiment

FIG. 34 shows a rolling bearing according to a sixteenth embodiment.

In this embodiment, the outer race 101 is monolithically formed and the inner race 102 is divided into two, each of the outer race and the inner race having two raceway surfaces 101a•101b, 102a•102b. The rolling elements 105 are disposed alternately crosswise on the circumference of circle so that the cut face 105e is directed to the inner race 102.

Accordingly, when an axial load or a moment load is applied, one of the adjacent rolling elements 105 is in point contact with the raceway surface 101a of the outer race and the raceway surface 102b of the inner race, which are opposed to each other, while the other of the adjacent rolling elements 105 is in point contact with the raceway surface 101b of the outer race and the raceway surface 102a of the inner race, which are opposed to each other. Also, when a radial load is applied, the rolling element may be in contact at a total of three points with the bearing rings under the load condition in some cases.

The other constitution and action are the same as in the fourteenth embodiment, except that the outer race 101 has two raceway faces 101a, 101b. Though the outer race 101 is not divided into two in this embodiment, the outer race 101 may be divided into two, or the inner race 102 may not be divided into two.

Though this invention has been described above in detail with reference to the specific embodiments, it will be apparent to those skilled in the art that various variations or modifications may be made thereto without departing from the spirit or scope of the invention.

This application is based on Japanese Patent Application (JP-A-2002-005034) filed on Jan. 11, 2002 and Japanese Patent Application (JP-A-2002-357237) filed on Dec. 9, 2002, their contents being incorporated herein for reference.

### Industrial Applicability

This invention has the above constitution, and exhibits the following effects.

(1) Since the rolling elements are incorporated without dividing at least one of a pair of bearing rings as conventionally, the manufacturing cost, assembling management and assembling cost are greatly reduced.

(2) Since the bearing rings are not divided, no related parts such as a bolt and a rivet for fastening required for division constitution are necessary whereby the number of parts is reduced. Consequently, the manufacturing cost, manufacturing operation and management required are reduced.

(3) Since the bearing is produced without impairing the working precision of the bearing ring formed as a monolithic type, the bearing precision is kept high.

(4) With the retainer constituting the invention, after a pair of bearing rings and the retainer are assembled, the rolling element is easily incorporated from the axial direction via the opening side in each pocket.

(5) Since the groove provided in the bearing ring has a function of rotating the rolling element in assembling the rolling element, and a function of retaining the lubricant such as oil and grease, the stable life of bearing is expected.

Also, this invention provided the constitution of the bearing contained in the direct drive motor, in which a plurality of rolling elements are incorporated between one pair of bearing rings, each of the bearing rings has a raceway groove composed of raceway surfaces having a larger radius than the radius of the rolling elements, at least one bearing ring being composed of two raceway surfaces, the rolling elements have an outside diameter of a rolling contact face with a curvature in an axial direction, and are arranged crosswise so that the central axes of rotation of the rolling elements are disposed crosswise alternately on the circumference of a circle, the outside diameter of each rolling element is contact with a raceway surface of one bearing ring and a raceway surface of the other bearing ring, at each one point, or two points in total, and the bearing is subjected to a preload, whereby the torque of the bearing is reduced below the conventional crossed roller bearing, and the heating is suppressed. Also, the rigidity is obtained by applying a preload on the bearing. Accordingly, the high speed is allowed without impairing the function of the conventional direct drive motor.

1-8. (canceled)

9. A rolling bearing, comprising:
a pair of bearing rings; and
a plurality of rolling elements incorporated between the pair of bearing rings;
wherein
each of said bearing rings has a raceway groove including a raceway surface having a larger radius than a radius of said rolling elements;
at least one of the raceway grooves includes two raceway surfaces;
said rolling elements have an outside diameter of a rolling contact face with a curvature in the axial direction, and are arranged crosswise so that the central axes of rotation of the rolling elements are skewed alternately in the circumferential direction of said bearing rings;
an outer peripheral face of each of said rolling elements is in contact with the raceway surface of one of the bearing rings and the raceway surface of the other of the bearing rings, which are opposed to each other, at each one point, or two points in total;
each of the pair of bearing rings is monolithically formed; and
a groove of desired depth is provided in a part of the raceway groove for one of said bearing rings.

10. The rolling bearing according to claim 9, further comprising: a retainer for retaining said plurality of rolling elements between said pair of bearing rings;
wherein said retainer has a plurality of pockets for retaining said rolling elements, each having an axial pocket face, with a face opposed to said axial pocket face being opened; and
said axial pocket faces are inclined alternately toward mutually opposite sides in the axial direction, corresponding to a direction of inclination of said rolling elements incorporated crosswise to each other in the circumferential direction of said bearing rings.

11. The rolling bearing according to claim 9, further comprising; a retainer for retaining said plurality of rolling elements between said pair of bearing rings;
wherein said retainer has a plurality of pockets for retaining said rolling elements, each having an axial pocket face; and
said axial pocket faces are inclined alternately toward mutually opposite sides in the axial direction, corresponding to a direction of inclination of said rolling elements incorporated crosswise to each other in the circumferential direction of said bearing rings.

12. The rolling bearing according to clam 9, further comprising: a retainer having a plurality of pockets for retaining said plurality of rolling elements between said pair of bearing rings;
wherein each of the pockets having an axial pocket face; and
each of said rolling elements has at least: one planar portion to be in contact with the axial pocket face.

13. A direct drive motor to be directly connected to a load, comprising:
a rotor; and
a stator disposed in at least one of an inside and an outside of the rotor; and
a bearing provided to support a rotation and load; wherein the bearing comprises:
a pair of bearing rings, and
a plurality of rolling elements incorporated between the pair of bearing rings;
each of said bearing rings has a raceway groove including a raceway surface having a larger radius than a radius of said rolling elements;
at least one of the raceway grooves includes two raceway surfaces;
said rolling elements have an outside diameter of a rolling contact face with a curvature in the axial direction, and are arranged crosswise so that the central axes of rotation of the rolling elements are skewed alternately in the circumferential direction of said bearing rings;
an outer peripheral face of each of said rolling elements is in contact with the raceway surface of one of the bearing rings and the raceway surface of the other of the bearing rings, which are opposed to each other, at each one point, or two points in total;
each of the pair of bearing rings is monolithically formed; and
a groove of desired depth is provided in a part of the raceway groove for one of said bearing rings.

14. A direct drive motor to be connected directly to a load, comprising: a rotor;
a stator disposed in at least one of an inside and an outside of the rotor; and
a bearing provided to support a rotation and load;
wherein the bearing comprises:
a pair of bearing rings, and
a plurality of rolling elements incorporated
between the pair of bearing rings;
each of said bearing rings has a raceway groove including a raceway surface having a larger radius than a radius of said rolling elements;
at least one of said raceway grooves includes two raceway surfaces;
said rolling elements have an outside diameter of a rolling contact face with a curvature in the axial direction, and are arranged crosswise so that the central axes of rotation of the rolling elements are skewed alternately with each other in the circumferential direction of said bearing rings; and
an outer peripheral face of each rolling element is in point contact with the raceway surface of one of the bearing rings and a raceway surface of the other of the bearing rings, which are opposed to each other, at each one point, or at two points in total.

15. The direct drive motor according to claim 14,
wherein each of said rolling element is an upper and lower sides cut ball having one set of opposing faces, in which the central axis of rotation of the rolling element is orthogonal to each opposing face.

16. The direct drive motor according to claim 14, wherein each of said rolling elements is a one-side cut ball having a cut face, in which the central axis of rotation of the rolling element is orthogonal to the cut face.
